(19) United States
(12) Patent Application Publication
(10) Pub. No.: US 2004/0262223 A1
(43) Pub. Date: Dec. 30, 2004

(54) Laminar mixing apparatus and methods

(75) Inventors: Abraham D. Strook, Ithaca, NY (US); Stephen K. W. Dertinger, Munich (DE); Armand Ajdari, Paris (FR); Igor Mezic, Goleta, CA (US); Howard A. Stone, Brookline, MA (US); George M. Whitesides, Newton, MA (US)

Correspondence Address: Timothy J. Oyer, Ph.D., Wolf, Greenfield & Sacks, P.C., 600 Atlantic Avenue, Boston, MA, 02210, US

(73) Assignee: President and Fellows of Harvard College, Cambridge, MA

(21) Appl. No.: 10/766,108

(22) Filed: Jan. 27, 2004

Related U.S. Application Data
(63) Continuation of application No. PCT/US02/23462, filed on Jul. 24, 2002.
(60) Provisional application No. 60/308,206, filed on Jul. 27, 2001.

(51) Int. Cl. B01D 11/00

(52) U.S. Cl. 210/634; 137/833; 422/101; 210/511; 436/178

(57) ABSTRACT

A mixing apparatus is used to effect mixing between one or more fluid streams. The mixing apparatus generally functions by creating a transverse flow component in the fluid flowing within a channel without the use of moving mixing elements. The transverse or helical flow component of the flowing fluid or fluids can be created by weak modulations of the shape of the walls of the channel. Transverse or helical flow component can be created by grooves features defined on the channel wall. Specifically, the present invention can be used in laminarly flowing fluids. The mixing apparatus and methods thereof can effect mixing of a fluid or fluids flowing with a Reynolds number of less than about 100. Thus, the present invention can be used to mix a fluid flowing in the micro-regime. The mixing apparatus can be used to mix a fluid in a microfluidic system to significantly reduce the Taylor dispersion along the principal direction. The mixing apparatus can be used to increase the effective exposed area to promote diffusion of components between or within the fluid or fluids.

### RELATED APPLICATIONS

This application is a continuation of International Application No. PCT/US02/23462, filed Jul. 24, 2002, which was published under PCT Article 21(2) in English, and claims priority to U.S. Application Ser. No. 60/308,206, filed Jul. 27, 2001. Both application are incorporated herein by reference.

### GOVERNMENT FUNDING

This invention was sponsored by the National Science Foundation Grant Numbers ECS-9729405 and ECS-0004030. The government has certain rights in this invention.

### BACKGROUND OF THE INVENTION

1. Field of the Invention

The present invention relates to mixing laminarly flowing fluids and, more particularly, to low Reynolds number mixing apparatus and to methods of use thereof.

2. Description of Related Art

Mixers are known in the art for mixing materials. These mixers may be useful in various applications such as mixing chemicals in industrial processes, mixing multi-part curing systems in adhesives, foams and molding compounds, mixing fuels and gases for combustion, mixing air into water for sewerage treatment, or wherever mixing needs to be accomplished.

There are generally two types of fluid flow, laminar flow and turbulent flow. In laminar flow, the fluid flows in smooth layers or lamina. This occurs when adjacent fluid layers slide smoothly over one another with mixing between layers or lamina occurring predominantly on a molecular level by diffusion. Turbulent flow is characterized by fluctuations of the velocity of the fluid in both space and time. Mixing of two or more substances in turbulent flow conditions generally proceeds faster than under laminar flow conditions.

The viscosity, the flow rate, and the density of the fluid along with the diameter of the flow path dictates the type of fluid flow. The more viscous two materials are or the smaller the cross-sectional dimension of the channel in which they flow, the higher the flow rate required in order to create a turbulent flow. These variables can be combined into a dimensionless parameter to characterize the flow called the Reynolds number according to

$$Re = \frac{D ρ v}{μ}$$

where D is the characteristic dimension of the path, ρ is the density of the fluid, ν is the fluid flow velocity, and μ is the viscosity of the fluid. Flows are typically laminar for Re less than 2300 and turbulent for Re less than 2300.

### SUMMARY OF THE INVENTION

In one embodiment, the present invention relates to an article. The article comprises a microfluidic channel defined therein and designed to have fluid flow therethrough in a principal direction. The microfluidic channel includes a channel surface having at least one groove or protrusion defined therein. The at least one groove or protrusion has a first orientation that forms an angle relative to the principal direction.

In another embodiment, the present invention provides an article comprising a microfluidic channel constructed and arranged to have a fluid flowing therethrough while creating a transverse flow component in the fluid.

In another embodiment, the present invention relates to an article comprising a structure having a channel defined therein, the channel designed to have a fluid flowing therethrough in a principal direction, the channel including a channel surface having a plurality of chevron-shaped grooves or protrusions formed in at least a portion of the channel surface so that each chevron-shaped groove or protrusion has an apex that defines an angle.

In yet another embodiment, the present invention relates to a structure. The structure comprises a first channel having a width that is less than about 1000 μm, a second channel having a width that is less than about 1000 μm and a third channel having a principal direction and a width that is less than about 1000 μm. The third channel connects the first and second channels and comprises channel surfaces having grooves or protrusions defined therein. The grooves or protrusions are oriented at an angle relative to the principal direction.

In another embodiment, the present invention relates to a method for dispersing a material in a fluid. The method comprises the steps of providing an article having a channel designed to have fluid flow therethrough in a principal direction, the channel including a channel surface having at least one groove or protrusion therein that traverses at least a portion of the channel surface, at least one groove or protrusion oriented at an angle relative to the principal direction and causing the fluid in the channel to flow laminarly along the principal direction.

In another embodiment, the present invention is directed to a method. The method comprises the steps of causing a first fluid to flow in a channel at a Reynolds number that is less than about 100, causing a second fluid to flow in the channel at a Reynolds number that is less than about 100 and creating a transverse flow component in the first and the second fluids to promote mixing between the first and second fluids.

In yet another embodiment, the present invention is directed to a method for forming a microfluidic article. The method comprises the steps comprising forming a first topological feature that has a smallest dimension that is less than about 1000 μm on a surface of a mold substrate, forming a second topological feature on the first topological feature to form a mold master, the second topological feature characterized by a length that traverses at least a portion of a section of the first topological feature, placing a hardenable material on the surface, hardening the material thereby creating a molded article having a microfluidic channel shaped from the first topological feature and at least one groove or protrusion shaped from the second topological feature and removing the microfluidic article from the mold master.

In another embodiment, the present invention is directed to a method for producing a helical flow path in a fluid flowing along a principal direction. The method comprises the step of providing a structure having a surface with a plurality of substantially linear grooves or protrusions oriented at an angle relative to the principal direction. The grooves or protrusions are formed to be parallel to and periodically spaced from each other. The method further comprises the step of causing the fluid to flow along the surface. The fluid flowing adjacent the surface has a Reynolds number that is less than about 100.

Other advantages, novel features, and objects of the invention will become apparent from the following detailed description of the invention when considered in conjunction with the accompanying drawings, which are schematic and which are not intended to be drawn to scale. In the figures, each identical, or substantially similar component that is illustrated in various figures is represented by a single numeral or notation. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

FIG. 1 is a schematic diagram of one embodiment of the present invention illustrating a system with channels defined in a substrate;

FIG. 2a is a schematic diagram showing a perspective view of one embodiment of the mixing apparatus with a fluid flowing therethrough;

FIG. 2b is an elevational view of the embodiment of FIG. 2a illustrating the grooves defined on a channel wall thereon;

FIG. 3 is a schematic diagram of one embodiment of the invention showing a channel having various configurations of grooves;

FIG. 4a is a schematic diagram of one embodiment of the invention showing a top elevational view of a mixing apparatus having grooves;

FIG. 4b is a diagram of the apparatus of FIG. 4a along b-b schematically showing the transverse or helical flow component of a flowing fluid;

FIG. 4c is a copy of a micrograph showing the transverse or helical flow component created within a fluid flowing in a mixing apparatus having grooves according to one embodiment of the present invention;

FIG. 5 is a schematic diagram of one embodiment of the present invention illustrating a mixing apparatus having chevron-shaped grooves defined on a wall therein;

FIGS. 6a-6f are copies of micrographs illustrating the cross-section of the mixing apparatus of FIG. 5 having two fluids flowing therethrough at different points along the length of the mixing apparatus;

FIG. 7 is a graph showing how the number of cycles affects the standard deviation of intensity, as a measure of mixing progress;

FIG. 8 is schematic diagram showing the dispersion of a plug of miscible solution along the principal direction of flow without (top) and with (bottom) continuous mixing according to one embodiment of the present invention; and

FIG. 9a-b are copies of micrographs showing the difference between axial dispersion without (FIG. 9a) and with (FIG. 9b) mixing according to one embodiment of the present invention.

### DETAILED DESCRIPTION

The present invention is directed to mixing apparatus and methods used to effect mixing between one or more fluid streams. The mixing apparatus generally functions by creating a transverse flow component in the fluid flowing within a channel without the use of moving mixing elements. The transverse or helical flow component of the flowing fluid can be created by the shape of the channel walls. For example, the transverse component can be created by grooves defined on the channel wall. The present invention can be used in systems where diffusion primarily controls fluid mixing. The term “transverse” is meant to describe a crosswise direction or at angle relative to a direction of a channel and the term “helical” is meant to describe a continuous plane curve that is extended in one direction and periodic in the other two. The term “principal direction” is meant as the direction of flow along a flow structure through which the bulk or the majority of the fluid can flow. For example, in a channel, the principal direction typically along the length of the channel, in contrast to across the width of the channel. Thus, the term “transverse flow component” is meant to describe a flow component that is oriented at an angle relative to a particular direction, preferably, relative to the principal direction. Notably, the present invention can be particularly useful when used in connection with microfluidic systems.

Patterned topography on surfaces according to the present invention can be used to generate chaotic flows in contexts other than pressure driven flows in microchannels. For example, chevron-shaped structures on the walls of round pipes and capillaries can provide efficient mixing. Thus, in one embodiment, fluid unit operation dependent on heat or mass transfer, such as a heat exchanger, may have turbulent flow in the bulk flowing fluid but may incorporate grooves, in a variety of geometries, on baffle plates to reduce or at least partially eliminate boundary limiting conditions that typically affect the overall transfer coefficient. That is, chaotic flows will also exist in the laminar shear flow in the boundary layer of an extended flow over a surface that presents the staggered herringbone features. This stirring of the boundary layer will enhance the rates of diffusion limited reactions at surfaces (e.g. electrode reactions) and heat transfer from solids into bulk flows. In another embodiment, electroosmotic flows in capillaries that contain the staggered herringbone features can be chaotic and promote stream mixing.

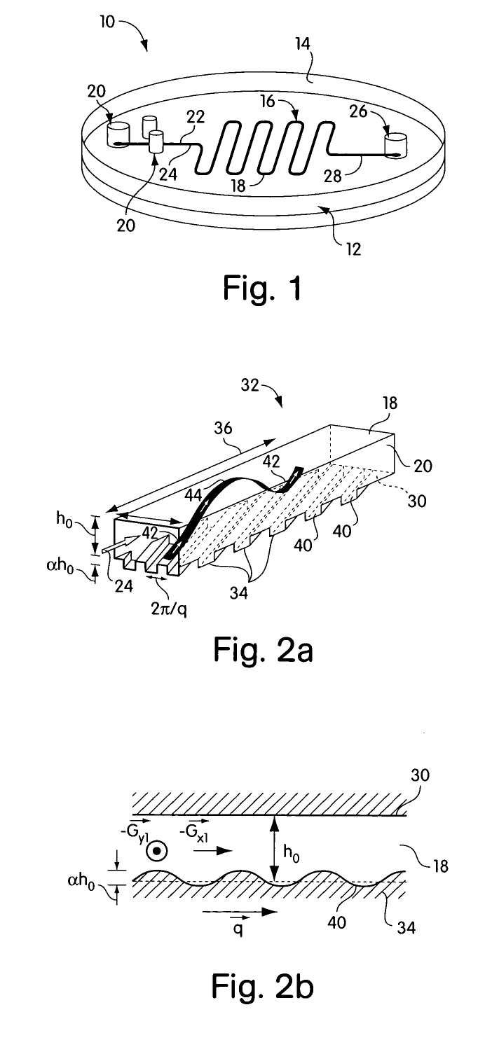

FIG. 1 illustrates a microfluidic system 10 according to one embodiment of the present invention. System 10 includes a substrate 12 with a surface 14 having formed or defined therein a structure 16 that can be a part of a network or array (not shown) of similar and interconnected structures and features. Structure 16 includes a channel 18 formed on surface 14 of substrate 12, a source 20 at a first position 22 that can provide a fluid 24 flowing in channel 18 and a sink 26 at a second position 28 wherein fluid 24 is received.

In another aspect, the present invention functions, in part, by increasing the effective exposed or interfacial area to promote diffusion of components between distinct volumes of the flowing fluid. That is, the present invention, in one embodiment, promotes mixing by diffusion by diverting a portion of the flowing fluid as, for example, by creating a transverse flow component in the flowing fluid. The transverse flow component may create a “folding effect” so that the effective exposed area through which diffusion of molecular species can occur is increased or, in another sense, the distance over which diffusion must act to eliminate concentration variations is decreased. Such an effect may reduce the rate of dispersion along the flow by carrying unit volumes of the fluid between fast and slow moving regions. In net effect, i.e., as the fluid progresses through the mixing apparatus, the mixing of the fluid or fluids is increased as the diffusion area is increased and, consequently, the time required to achieve mixing to a desired homogeneity is reduced. The transverse flow component may be viewed, analogously, to the effect created by turbulent flow wherein localized eddy currents are created as a consequence thereof. In another aspect, the transverse flow component can be viewed as stretching the volumes of the fluid at an exponential rate as the fluid is “wound” helically along the principal direction of the flow.

The present invention can be used in laminarly flowing fluids. Thus, as described below, the mixing apparatus and methods thereof are particularly suitable to mix a fluid flowing in the micro-regime. As used herein, the term “microchannel” refers to a channel that has a characteristic dimension, i.e., a width or a depth, that is less than about 1000 microns (μm). System 10 can be used to mix a fluid or fluids in a microfluidic system to significantly reduce the Taylor dispersion along the principal direction. The present invention may be used advantageously in microfluidic systems wherein the laminar flow is particularly predominant. Fluids flowing in such systems are typically characterized as laminar Poiseuille flows with low Reynolds numbers. As described further below, the mixing apparatus can be designed to create a transverse flow component within such flows that are non-turbulent, preferably with Re having a Reynolds number that is less than about 2000, preferably, less than 100, more preferably, less than about 12, and even more preferably, less than 5.

Thus, in one embodiment, grooves or protrusions can be oriented in a variety of configurations or combinations to effect transverse flow components of the fluid or fluids flowing therethrough that is independent of Reynolds number or as Reynolds number goes to zero.

The present invention, as embodied in the schematic illustration of FIG. 1, can be used in a system wherein a desired process operation may be carried out including, but not limited to, flowing a fluid, facilitating a chemical reaction, dissolving a substance in a medium, depositing or precipitating a material on a surface, mixing a fluid or fluids to achieve homogeneity and exposing a first material to a second material. For purposes of illustration, a system 10, as shown in FIG. 1, will be described with respect to a flowing fluid. As used herein, fluid can refer to a gas or a liquid.

According to one embodiment, channel 18 can be formed as a mixing apparatus 32 to facilitate mixing a fluid or fluids flowing therethrough. As schematically illustrated in the embodiment of FIG. 2a, channel 18 comprises a mixing apparatus 32 having a rectangular cross-section with a width and a depth or height. Grooves, undulation or protrusion features 34 are formed on at least one channel surface 30. Fluid 24 flowing in channel 18 has a principal direction, indicated by reference 36, along the lengthwise direction of the channel. In other embodiments, the microfluidic channel can have a variety of cross-sectional shapes including, but not limited to, rectangular, circular and elliptical.

In some embodiments, the groove is oriented to form an angle relative to the principal direction. Grooves 34 on channel surface 30 are constructed and arranged to create an anisotropic response to an applied pressure gradient thereby producing at least one three-dimensional flowpath such as transverse flow component in fluid 24 flowing in channel 18. Grooves 34 can be formed as undulations that provide reduced flowing resistance along the valleys 40 of grooves 34. That is, fluid near channel surface 30 having groove 34 is exposed to reduced flow resistance at or near the valleys 40 creating a transverse flow component 42. As the fluid flows further along principal direction 36, transverse flow components 42 are further generated or increase in magnitude through additional grooves 32 defined along channel surface 30. The resultant effect creates a circulating or helical flow path 44.

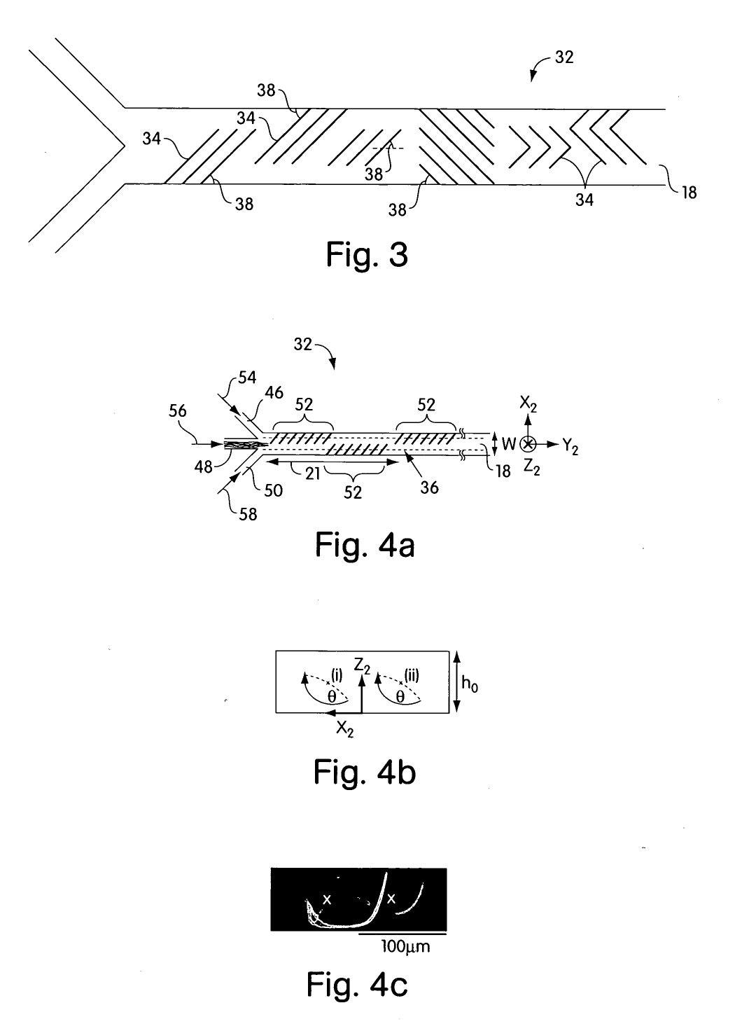

Grooves 34 typically have a width and a height that is less than the width and height of mixing apparatus 32 and can be arranged periodically along the lengthwise direction of mixing apparatus 32. As shown in the schematic illustration of FIG. 3, grooves 34, defined on channel surface 30 of mixing apparatus 32, can have a variety of configurations and combinations. That is, in one embodiment, grooves 34 can be oriented at an angle 38 and can extend substantially or partially across the cross-section of mixing apparatus 32. Further, it can be seen that those of ordinary skill may recognize that grooves 34 can have a variety of geometrical cross-sections including, but not limited to rectangular, circular and parabolic. Grooves or protrusions 34 can be oriented in a variety of configurations or combinations to effect transverse flow components of the fluid or fluids flowing therethrough that is independent of Reynolds number or as Reynolds number goes to zero.

In another embodiment, grooves 34 can be arranged as a set of grooves, wherein each groove is arranged periodically as shown in FIGS. 3-5. Thus, in one embodiment, the mixing apparatus can comprise at least one set, preferably at least two sets and more preferably, a plurality of sets wherein each set comprises a plurality of grooves arranged periodically therein. In another embodiment, each set comprises a periodic arrangement of grooves that are offset from each other such that at least one set is at least partially coextensive with at least another set. In another embodiment, the mixing apparatus comprises a set comprising a plurality of grooves having various configurations. Thus, as illustrated in FIG. 3, the grooves may be oriented at an angle relative to the principal direction, may be offset, traverse at least a portion of the cross-section of the mixing apparatus, may be periodically arranged to form a set or a repeating cycle and may have chevron shapes. Chevron-shaped structures typically have at least one apex, which is formed by lines intersecting at an angle. The term “chevron-shape” is meant to represent a structure having a V-shape or zigzag shape. And, as used herein, the term “chevron-shaped” is meant to include structures formed by intersecting linear and non-linear lines as well as symmetrical and asymmetrical V-shapes and structures having multiple intersections.

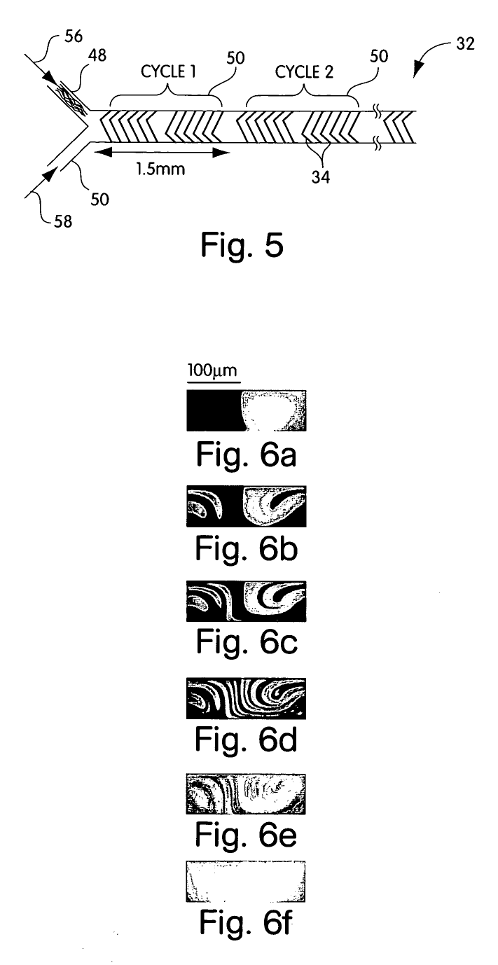

In one embodiment, the mixing apparatus comprises herringbone-shaped or chevron-shaped features that are asymmetric with respect to a lengthwise axis of the channel forming the mixing apparatus. In another embodiment, the asymmetry of the chevron-shaped features vary in alternating or in other predetermined fashion. For example, with reference to FIG. 5, the asymmetry of chevron-shaped grooves in the first set differs from that of the adjacent set.

As used, herein, a pair of sets forms a cycle of the mixing apparatus. The term “cycle” is refers to a plurality of sets that are sufficient to produce a spiral flow component. Thus, in one embodiment, one cycle refers to a first set of similarly grooves and a second set of similarly shaped grooves. A set of cycles may comprise a plurality of cycles, each cycle comprising sets of shaped features and each cycle may be geometrically distinguishable from another cycle. For example, a set may comprise a group of chevron-shaped grooves defining a first apex group that are similarly shaped and a second set of chevron-shaped grooves defining a second apex group that are similarly shaped, the second apex group are “offset” from the first apex group such that the apex is displaced from the first group relative to an axis, e.g., the axis along the principal direction. Such a design can be characterized by, among others, the degree of asymmetry as measured by the fraction of the width of the channel that is spanned by the wider branch of the chevron-shaped grooves and the amplitude of the rotation of the fluid, as measured by θ and shown in FIG. 4b, that is induced by the chevron-shaped structures. The amplitude of the rotation is influenced by the geometry of the undulations and the number of undulations per set or half cycle.

Thus, in another embodiment, the mixing apparatus comprises a first channel disposed in a structure having a width that is less than about 5000 μm, a second channel also disposed in the structure and also having a width that is less than about 5000 μm and a third channel with a principal direction and having a width that is less than about 5000 μm that connects the first and second channels and comprising channel surfaces with grooves, which are oriented at an angle relative to the principal direction. However, those of ordinary skill practicing the invention may readily recognize that the structures described herein may be used to effect mixing in any non-turbulent flow system. Thus, a system that may have a relatively large characteristic dimension may nonetheless be non-turbulent if the fluid flowing therein the fluid flowing adjacent to the features that create a transverse flow component are non-turbulent. For example, mixing may be effected by creating a transverse flow component, with a use of grooves, in a fluid flowing on a surface that extends essentially infinitely in two dimensions. Notably, the fluid may be flowing non-turbulently adjacent to the grooves but may be flowing turbulently away from the surface. Thus, the invention may be used in a surface or a mixing apparatus regardless of the dimension of the channel.

The staggered herringbone mixing apparatus based on patterned topography on the surface of microchannels can offer a general solution to the problem of mixing fluids in microfluidic systems. The simplicity of its design allows it to be easily integrated into microfluidic structures with standard microfabrication techniques. Such a mixing apparatus can operate over a wide range of Re, specifically, all values less than about 100.

Substrate 12 can be formed from any suitable material that can used to create structures 16 and performing the desired process operation. Substrate 12 can be formed of a polymeric material such as a random or block polymeric or copolymeric material; suitable polymeric materials include polyurethane, polyamide, polycarbonate, polyacetylene, polysiloxane, polymethylmethacrylate, polyester, polyether, polyethylene terephthalate and/or blends or combinations thereof. Substrate 12 can also be a ferrous, non-ferrous, transition or precious metal such as steel, platinum, gold and/or alloys or combinations thereof. Substrate 12 can be formed of a semiconductor material such as silicon and gallium arsenide including nitrides and oxides formed thereof. The selection of materials suitable to create structures and perform the desired process operation can be performed by those of ordinary skill practicing the field.

Systems of the present invention can be prepared using soft lithographic techniques. One such technique is discussed by McDonald et al. in Electrophoresis 21, 27-40 (2000), which is incorporated in its entirety. Master structures are typically made with two step photolithography, which generally involves preparing a first photolithographic layer defining a positive image of the channel or mixing apparatus and a second photolithographic layer defining a positive image of the pattern of grooves or undulation. The first photolithographic layer can be used as a positive image of the channel. The second layer can be used as a positive image of the pattern of undulations. This second pattern is typically aligned to lie on top of the channel using a mask aligner. The master structures can then used as molds to create a substrate made from polydimethylsiloxane (PDMS).

To close the molded channel, the PDMS substrates are typically exposed to plasma for one minute and can then be sealed with a glass cover slip. The thickness of the cover slip is typically selected to be optically compatible with the oil immersion objectives of the confocal microscope. For example, a No. 1 glass cover slip can be used with a XX Leica confocal microscope with a 40×/1.0 n.a. objective. It should be understood that other techniques can also be used to form systems of the present invention.

The functions and advantages of these and other embodiments of the present invention can be further understood from the examples below. The following examples are intended to illustrate the benefits of the present invention, but do not exemplify the full scope of the invention.

### EXAMPLE 1

This example, with reference to FIGS. 4a-c, discusses one embodiment of the present invention and is directed to mixing fluids in a mixing apparatus. The broad dark lines, shown in FIG. 4a, represent undulations in the channel surface. A sequential pair of grooves form one cycle. The grooves were oriented at a 45-degree angle relative to the principal direction. Mixing apparatus 32 was a microfluidic article with a rectangular cross-section, which was about 200 μm wide and comprised a plurality of fluid inlets 46, 48 and 50, a plurality of sets 52 of grooves comprised a cycle, each set with at least one groove 34 arranged periodically along the principal direction. Fluids 54, 56, and 58 were introduced through inlets 46, 48 and 50, respectively wherein fluid 56 is comprised a fluorescent dye. As the fluids flowed laminarly at a Reynolds number that is less than about 100, a transverse flow component 42 was created in the aggregated fluid in mixing apparatus 32 as schematically depicted in FIG. 4b and as shown in the copy of a micrograph in FIG. 4c. The lighter portions represent the fluorescent dye introduced in fluid 56. This example showed that the grooves in the mixing apparatus can create transverse flow components in a fluid having a Reynolds number that is less than about 100.

### EXAMPLE 2

This example, with reference to FIGS. 5 and 6a-c, discusses another embodiment of the present invention and directed to mixing fluids in a mixing apparatus, specifically, a staggered herringbone mixing apparatus having chevron-shaped grooves. The broad dark lines, shown in FIG. 5, represent the chevron-shaped undulations in the channel surface. A sequential pair of grooves form one cycle. The grooves were oriented at a 45-degree angle relative to the principal direction. The mixing apparatus was a microfluidic article with a rectangular cross-section, which was about 200 μm wide by 100 μm tall and comprised a plurality of fluid inlets 48 and 50, a plurality of sets 52 of 50 μm×50 μm rectangular chevron-shaped grooves comprised a cycle, each set with six chevron-shaped groove 34 arranged periodically along the principal direction. The sets were disposed from each other such that the loci of apex of one set was offset from the loci of apex of an adjacent set. Fluids 56 and 58 were introduced through inlets 48 and 50 respectively from their respective reservoirs (not shown). Fluid 56 comprised a fluid, poly(ethylenimine), MW 750,000, fluorescently labeled with 1% FITC in 0.1 wt. % solution while fluid 58 comprised the same solution without FITC. The fluids were pumped through the mixing apparatus at a velocity of about 2.7 cm/s by applying a constant pressure on each fluid reservoir with compressed air. The corresponding Reynolds number was determined to be about 4×10⁻² and the Péclet number was determined to be about 3.3×10⁺⁴.

FIGS. 6a-f are copies of micrographs of vertical cross-sections along the mixing apparatus made using a XX Leica confocal microscope with a 40×/1.0 n.a. objective. These show the distribution of the fluorescent molecules before the first cycle (FIG. 6a), and progressively after the first (FIG. 6b), second (FIG. 6c), fourth (FIG. 6d), eight (FIG. 6e) and sixteenth cycles (FIG. 6f). FIGS. 6b-f shows that generation of a transverse flow components (depicted by the lighter portions) in the fluid as the fluid flows through multiple cycles. Notably, the fluid appears homogeneous after the sixteenth cycle. Thus, this example shows that a mixing apparatus having chevron-shaped grooves can be used to mix fluids flowing at very low Reynolds numbers.

### EXAMPLE 3

In this example, the efficiency of mixing was evaluated. Four fluids were prepared with fluorescent pigment similar to the fluids described in Example 2. The fluids were introduced under varying conditions into a mixing apparatus. The fluids flowed with a Reynolds number that was less than about 7.5 and, respectively, with Péclet numbers of 1.6×10² (circle), 1.9×10² (square), 7.4×10³ (triangle) and 3.3×10⁴ (diamond). Péclet number is the product of the Reynolds and Prandtl numbers. The latter is the viscosity, μ, of a fluid divided by its molecular diffusivity. Thus, the Péclet number is

$$Pe = \frac{Uh}{D}$$

where U is the average velocity, h is the height of the channel and D is the diffusivity of the diffusing material in the medium.

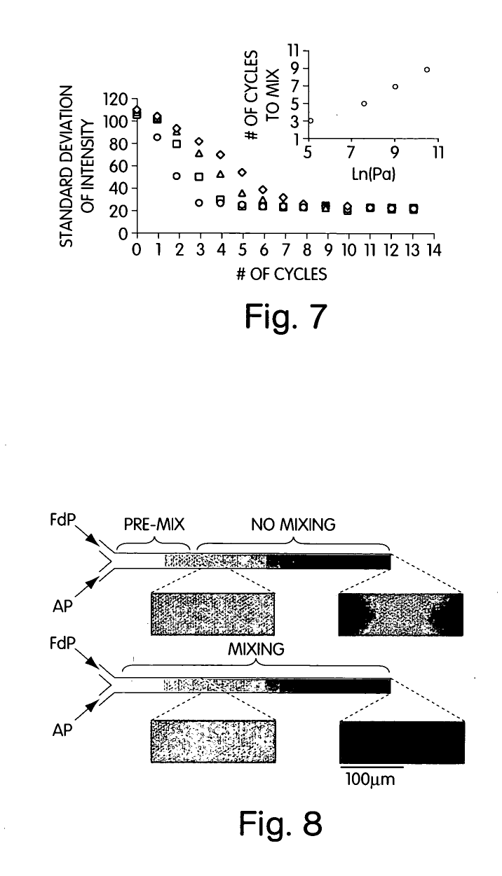

Fluorescence intensity was found to be proportional to the concentration of fluorescent molecules and accordingly, mixing efficiency was characterized as the variation of intensity of the fluorescence. Stated another way, as the degree of mixing increases, the variation measured as the standard deviation of fluorescent intensity approaches zero. FIG. 7 is a chart showing the standard of deviation of intensity relative to the number of cycles for fluids having various Péclet numbers. As expected, a fluid with a lower Péclet number required less mixing cycles than a fluid with a higher Péclet number because diffusion was the predominant mechanism of mixing. The standard deviation approached 20, not zero, because, it is believed, of optical effects, shadows in the field of view of the microscope, and the noise of the photodetector.

The example shows that the number of mixing cycles that are required for total mixing grows slowly with Péclet number but that the mixing apparatus according to the present invention can be used to efficiently mix laminarly flowing fluids. The inset shows that the number of cycles required for total mixing is linearly proportional to log(Pe).

### EXAMPLE 4

This example shows the reduction of axial dispersion (the spreading of a plug of miscible solution along the principal direction of the flow) in a mixing apparatus according to one embodiment of the present invention. Two channels having chevron-shaped undulations, each 200 μm×70 μm×20 cm, were produced as shown schematically in FIG. 8. The top mixing channel had ten mixing cycles near the entrance while the bottom had mixing cycles substantially throughout its length. Steady streams of alkaline phosphatase (AP) and fluorocien diphosphate (FdP) were introduced into each mixing channel. AP reacted as in came in contact with FdP to produce a fluorescent molecule, fluorocien. The Péclet number was determined to be less than about 1.7×10⁴.

The insets are copies of confocal images of the cross-section of the mixing channel. Specifically, the left insets are copies of confocal images after ten mixing cycles while the right insets, measured about 16 cm downstream, show the effect without (top) mixing and with (bottom) continuous mixing (at about 100 mixing cycles). As shown in the contrasting images, the fluid that is continuously mixed (bottom) was more homogeneous than the fluid that was not mixed (top). Homogeneity in these images indicates that the distribution of lifetimes (of the reaction product) in the flow is narrow and that there is little axial dispersion. Thus, this example demonstrates the benefit of using aspects of the present invention to increase conversion efficiency in a laminarly flowing reactive system.

### EXAMPLE 5

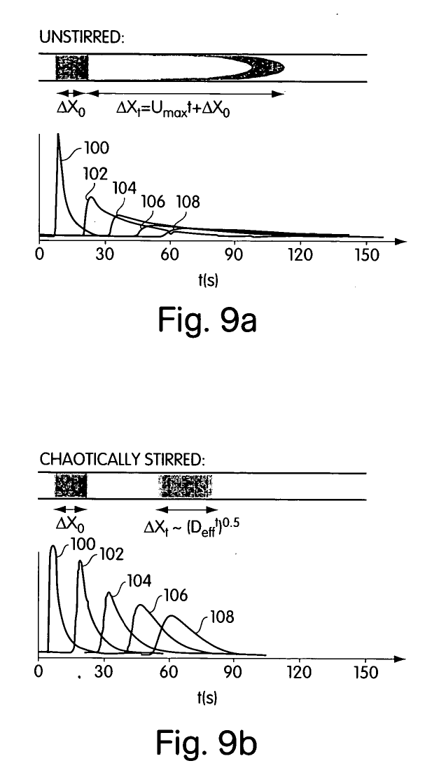

FIGS. 9a-b shows axial dispersion with and without efficient mixing and demonstrates the reduction of dispersion of a plug of miscible solution in a chaotically stirred Poiseuille flow (FIG. 9b) relative to an unstirred Poiseuille flow (FIG. 9a).

FIG. 9a shows unstirred Poiseuille flow in a rectangular channel that is 21 cm×200×70 μm². FIG. 9b shows stirred flow in a staggered herringbone mixing apparatus that is 21 cm×200×85 μm². A plug of fluorescent dye was introduced into both structures. The traces represent the time evolution of the total fluorescence intensity as observed with a fluorescence microscope having 5× lens that averages over the cross-section of the channel at positions 0.20 cm (100), 0.62 cm (102), 1.04 cm (104), 1.46 cm (106), and 1.88 cm (108) downstream from the entrance of the channel. These distances corresponded to 10, 30, 50, 70, and 90 mixing cycles, respectively. In the unstirred case, FIG. 9a, the plug was distorted and spread over most of the length of the channel. In the chaotically stirred flow, FIG. 9b, the plug retained its shape and broadened only mildly. The appropriate fluid flow parameter were calculated to be Uₐ˜0.3 cm/s; Pe˜1.5×10⁴; Lₘₐₓ/h=20 cm/80 μm=2500.

FIG. 9a illustrated that for high Pe, the width of a plug in an unstirred Poiseuille flow grew linearly with time at the maximum flow speed, Uₘₐₓ (the fluid at the center of the channel moves at Uₘₐₓ while fluid at the walls is stationary); this rapid broadening will continue for a distance down the channel, L˜hPe. The traces record the total fluorescence intensity, integrated over the cross-section of the channel, as a function of time at equally spaced positions along the channel.

In the absence of stirring, the initial distribution of fluorescence rapidly distorted. The peak intensity also drastically reduced. The plugs developed long tails due to the fluorescent solution that was trapped in the slowly moving regions of the flow near the walls. This effect, it is believed, is detrimental for the transfer of discrete plugs of fluid in laminar flows in channels and pipes.

In contrast, in chaotically stirred flow, shown in FIG. 9b, a plug of solution broadened more slowly because, it is believed, volumes of the solution moved between fast and slow regions of the flow. Thus, the broadening of a plug should rapidly become diffusive, i.e., it is believed that the broadening is proportional to \sqrt{t} and should occur after nₘ cycles with an effective diffusivity, D_{eff} that is a function of the molecular diffusivity and the characteristics of the flow as discussed by Jones et al. in J. Fluid Mech, 280, pp. 149-172 (1994), which is incorporated by reference in its entirety.

The traces shown in FIG. 9b demonstrated improved reduction of dispersion in a flow that was stirred in a mixing apparatus with a staggered herringbone structure, i.e., chaotically stirred flow. As shown in FIG. 9b, in the chaotically stirred flow, the shape of the distribution of fluorescence was largely maintained, and the peak intensity dropped gradually.

Those skilled in the art would readily appreciate that all parameters and configurations described herein are meant to be exemplary and that actual parameters and configurations will depend upon the specific application for which the mixing systems and methods of the present invention are used. Those skilled in the art will recognize, or be able to ascertain using no more than routine experimentation, many equivalents to the specific embodiments of the invention described herein. For example, those skilled in the art may recognize that the mixing apparatus of the present invention may be used to mix a fluid having a solid dissolving therein and that the present invention may be used to improve the transfer properties, heat or mass transfer, of a fluid flowing adjacent a surface having the features of the present invention. Moreover, the present invention can be seen to provide efficient mixing at low Reynolds numbers but should be effective for any non-turbulent flow, Reynolds number less than about 2300, and need not be restricted to a systems with Reynolds number less than 100 or with dimensions less 1000 μm.

It is, therefore, to be understood that the foregoing embodiments are presented by way of example only and that, within the scope of the appended claims and equivalents thereto, the invention may be practiced otherwise than as specifically described. The present invention is directed to each individual feature, system, or method described herein. In addition, any combination of two or more such features, systems or methods, if such features, systems or methods are not mutually inconsistent, is included within the scope of the present invention.

What is claimed:

1. An article comprising a microfluidic channel defined therein designed to have fluid flow therethrough in a principal direction, the microfluidic channel including a channel surface having at least one groove or protrusion defined therein, the at least one groove or protrusion having a first orientation that forms an angle relative to the principal direction.

2. The article of claim 1, wherein the microfluidic channel has at least one of a width and a depth that is less than about 1000 μm.

3. The article of claim 2, wherein the microfluidic channel has at least one of a width and a depth that is less than about 500 μm.

4. The article of claim 3, wherein the microfluidic channel has at least one of a width and a depth that is less than about 200 μm.

5. The article of claim 1, wherein the substrate comprises a polymer.

6. The article of claim 1, wherein the angle is less than about 90 degrees.

7. The article of claim 1, wherein the groove or protrusion has a depth that is less than a width of the microfluidic channel.

8. The article of claim 1, wherein the groove or protrusion has a depth that is less than a depth of the microfluidic channel.

9. The article of claim 1, wherein the groove or protrusion has a width that is less than a width of the microfluidic channel.

10. The article of claim 1, wherein the microfluidic channel includes a first inlet.

11. The article of claim 10, wherein the microfluidic channel includes a second inlet.

12. The article of claim 1, wherein the microfluidic channel has a substantially circular cross-section.

13. The article of claim 1, comprising a plurality of grooves or protrusions formed in the channel surface.

14. The article of claim 13, wherein each of the grooves or protrusions is parallel to each other.

15. The article of claim 14, wherein the parallel grooves or protrusions are periodically spaced along the channel surface to form a first set of parallel grooves or protrusions.

16. The article of claim 15, wherein the microfluidic channel has a width and the first set of parallel periodically-spaced grooves or protrusions traverse the width.

17. The article of claim 13, wherein the channel surface has a second set of parallel periodically-spaced grooves or protrusions traversing at least a portion of the channel surface at a second orientation.

18. The article of claim 17, wherein the second set of parallel periodically-spaced grooves or protrusions are at least partially coextensive with the first set of parallel periodically-spaced grooves or protrusions.

19. The article of claim 17, wherein the first and second sets of parallel grooves or protrusions form a repeating pattern.

20. The article of claim 1, wherein at least one groove or protrusion has at least two sections.

21. The article of claim 20, wherein at least one section is substantially linear.

22. The article of claim 21, wherein the sections intersect to form at least one chevron-shaped groove.

23. The article of claim 22, wherein a plurality of chevron-shaped grooves or protrusions are formed in the channel surface.

24. The article of claim 23, wherein the chevron-shaped grooves or protrusions are periodically spaced along the channel surface.

25. The article of claim 1, wherein a second groove or protrusion is defined in the channel surface, the second groove or protrusion having a second orientation relative to the principal direction.

26. The article of claim 1, wherein the substrate has a network of microfluidic channels fluidly connected to the microfluidic channel.

27. The article of claim 1, wherein the microfluidic channel is formed in a unitary substrate.

28. An article comprising a microfluidic channel constructed and arranged to have a fluid flowing therethrough while creating a transverse flow component in the fluid.

29. The article of claim 28, wherein the microfluidic channel is constructed and arranged so that fluid flowing therethrough has a Reynolds number that is less than about 12.

30. The article of claim 29, wherein the microfluidic channel is constructed and arranged so that fluid flowing therethrough has a Reynolds number that is less than about 5.

31. The article of claim 28, wherein the microfluidic channel has a width that is less than about 1000 μm.

32. The article of claim 28, further comprising a network of microfluidic channels fluidly connected to the microfluidic channel.

33. The article of claim 28, wherein the microfluidic channel is constructed and arranged to create at least one helical flow path in a fluid flowing therethrough.

34. The article of claim 28, wherein the microfluidic channel is constructed and arranged to have a substantially circular cross-section.

35. The article of claim 28, wherein the microfluidic channel is constructed and arranged to have a rectangular cross-section.

36. The article of claim 28, wherein the transverse flow component is created regardless of the Reynolds number of the fluid flowing in the microfluidic channel.

37. An article comprising a structure having a channel defined therein, the channel designed to have a fluid flowing therethrough in a principal direction, the channel including a channel surface having a plurality of chevron-shaped grooves or protrusions formed in at least a portion of the channel surface so that each chevron-shaped groove or protrusion has an apex that defines an angle.

38. The article of claim 37, wherein the angle of the apex is about 45-degrees.

39. The article of claim 37, wherein the channel includes a first set of chevron-shaped grooves or protrusions and a second set of chevron-shaped grooves or protrusions.

40. The article of claim 39, wherein the apex of each of the first set of chevron-shaped grooves or protrusions are aligned offset relative to the apex of each of the second set of chevron-shaped grooves or protrusions.

41. The article of claim 40, wherein the structure comprises a capillary tube.

42. The article of claim 40, wherein the structure comprises a polymer.

43. The article of claim 37, wherein the channel has a width that is less than about 1000 μm.

44. The article of claim 43, wherein the channel has a width that is less than about 200 μm.

45. The article of claim 37, wherein the channel is fluidly connected to a network of microfluidic channels.

46. The article of claim 37, wherein the chevron-shaped grooves or protrusions are periodically-spaced from each other.

47. The article of claim 37, wherein the channel has a rectangular cross-section.

48. The article of claim 37, wherein the channel has a circular cross-section.

49. The article of claim 37, wherein the channel is a microfluidic channel.

50. The article of claim 37, wherein the channel is defined on a unitary structure.

51. A structure comprising:
a first channel having a width that is less than about 1000 μm;
a second channel having a width that is less than about 1000 μm; and
a third channel having a principal direction and a width that is less than about 1000 μm, the third channel connecting the first and second channels and comprising channel surfaces having grooves or protrusions defined therein, the grooves or protrusions oriented at an angle relative to the principal direction.

52. The structure of claim 51, wherein the structure comprises a polymer.

53. A method for dispersing a material in a fluid comprising:
providing an article having a channel designed to have fluid flow therethrough in a principal direction, the channel including a channel surface having at least one groove or protrusion therein that traverses at least a portion of the channel surface, at least one groove or protrusion oriented at an angle relative to the principal direction; and
causing the fluid in the channel to flow laminarly along the principal direction.

54. The method of claim 53, wherein the fluid flowing in the channel has a Reynolds number that is less than about 100.

55. The method of claim 54, wherein the fluid flowing in the channel has a Reynolds number that is less than about 10.

56. The method of claim 55, wherein the fluid flowing in the channel has a Reynolds number that is less than about 5.

57. The method of claim 53, wherein the step of causing the fluid to flow in the channel results in a fluid residence time in the channel of less than about 20 seconds.

58. A method comprising:
causing a first fluid to flow in a channel at a Reynolds number that is less than about 100;
causing a second fluid to flow in the channel at a Reynolds number that is less than about 100; and
creating a transverse flow component in the first and the second fluids to promote mixing between the first and second fluids.

59. The method of claim 58, wherein the channel has a width that is less than about 1000 μm.

60. The method of claim 59, wherein the step of creating a transverse flow component creates at least one helical flow path.

61. The method of claim 58, wherein the second fluid has a Reynolds number that is about equal to the Reynolds number of the first fluid.

62. The method of claim 61, wherein the first fluid has a composition that differs from a composition of the second fluid.

63. A method for forming a microfluidic article comprising:
forming a first topological feature that has a smallest dimension that is less than about 1000 μm on a surface of a mold substrate;
forming a second topological feature on the first topological feature to form a mold master, the second topological feature characterized by a length that traverses at least a portion of a section of the first topological feature;
placing a hardenable material on the surface;
hardening the material thereby creating a molded article having a microfluidic channel shaped from the first topological feature and at least one groove or protrusion shaped from the second topological feature; and
removing the microfluidic article from the mold master.

64. The method of claim 63, wherein the hardenable material comprises a cross-linkable polymer.

65. The method of claim 64, wherein the step of hardening the material comprises applying heat to the material.

66. The method of claim 65, wherein the groove or protrusion has a depth that is less than a width of the first topological feature.

67. A method for producing a helical flow path in a fluid flowing along a principal direction comprising:
providing a structure having a surface with a plurality of substantially linear grooves or protrusions oriented at an angle relative to the principal direction, the grooves or protrusions formed to be parallel to and periodically spaced from each other; and
causing the fluid to flow along the surface, the fluid flowing adjacent the surface having a Reynolds number that is less than about 100.
